(19) United States
(12) Patent Application Publication
(10) Pub. No.: US 2011/0042955 A1
(43) Pub. Date: Feb. 24, 2011

(54) MARINE ENERGY EXTRACTION SYSTEMS AND UNITS

(76) Inventor: Robert A. BENSON, Amesbury, MA (US)

Correspondence Address: KENYON & KENYON LLP, ONE BROADWAY, NEW YORK, NY, 10004, US

(21) Appl. No.: 12/861,565

(22) Filed: Aug. 23, 2010

Related U.S. Application Data
(60) Provisional application No. 61/274,806, filed on Aug. 21, 2009.

(51) Int. Cl. F03B 13/22

(52) U.S. Cl. 290/53

(57) ABSTRACT

A floating at sea or beached structure having hydraulic power cells capable of capturing, dissipating and distributing wave action energy comprising flexible mats with energy capture cells all preferably constructed of elastic structural and, where necessary, flotation materials with distributed energy being in the form of a pressurized hydraulic stream.

### CROSS-REFERENCE TO RELATED APPLICATIONS

The present application claims priority to, and the benefit of, co-pending U.S. Provisional Application 61/274,806 filed Aug. 21, 2009. The contents of this provisional application is incorporated herein by reference in its entirety.

### FIELD OF THE INVENTION

The present invention relates generally to systems for recovering energy from waves and, more particularly, the present invention relates to an apparatus and methods for transforming fluid displacement caused by waves into electrical power.

### BACKGROUND OF THE INVENTION

Currently, the majority of global energy consumption comes from non-renewable sources, such as oil, coal, natural gas, and other such fossil fuels. The use of such fossil fuels in the global energy consumption releases substantial amounts of carbon dioxide and other pollutants into the atmosphere. With a finite supply of fossil fuels available and growing concerns over the impact of carbon dioxide, continued reliance on fossil fuels as a primary source of energy is not indefinitely sustainable.

One approach to sustaining the current global energy consumption rate and accounting for future increases in consumption is to research and develop novel and improved methods for generating energy from renewable sources. Sources of renewable energy include water-powered energy, wind-powered energy, solar energy, and geothermal energy. Of the current practical renewable energy sources, water-powered energy, and specifically wave-powered energy, may hold the most promise for developing a substantial renewable energy source to meet growing global energy needs.

It has been long understood that ocean waves contain considerable amounts of energy. Given the high level of energy concentration present in waves, particularly in breaking waves, and the vast areas available for harvesting such energy, wave-powered energy technology represents a significant renewable energy source. Numerous systems have been developed in an attempt to efficiently capture the energy of waves; however, no prior conceived systems or methods have achieved the efficiency or cost-effectiveness required to make wave-powered energy a viable alternative energy source.

Wave energy recovery systems must successfully operate in very hostile marine or freshwater environments. Such environments are prone to violent storms and the deleterious impact of salt water, plant life, and animal life. Further, due to the offshore location of such systems, a successful system must include an efficient means for delivering the energy output to shore.

Accordingly, one of the first design criteria for a Marine Energy Extraction (MEX) system or unit is its survivability in the ferocious marine environment, i.e. the oceans, seas and coastline waters. Marine Energy Extraction relies partly on the use of flexible floating structures. These structures commercially known as floating or submersible “SEABOOMS” have been employed successfully throughout the world for many years commencing in 1970. Such “SEABOOMS” are described for example in U.S. Pat. No. 3,818,708. A second design criteria is to create a desired commercial and/or environmental/societal advantage which here is to cost effectively produce clean, renewable energy.

These and other technical challenges have been addressed and overcome by this invention as herein described.

### SUMMARY

The invention relates to a hydraulic power cell which may be used in a floating or non-floating structure comprising a series of hydraulic power cells, ranging from small (not quite minute) sea anemone-like tentacles to huge piston-like systems usually combined to capture the majority of motion energy of widely varying frequencies and magnitudes which exist in any body of water, preferably at sea. The size and magnitude of activity of the body of water naturally have a major bearing on the magnitude of energy available. The invention makes use of the ability to take the random and sporadic energy from the various elastic hydraulic power cells and storing it in a water energy storage system which stores and dampens energy surges so that they can be tapped on a relatively steady and regular basis.

In one embodiment the present invention provides a hydraulic power cell which captures, stores and releases energy comprising:

a tubular member having strengthened elastic walls which are resiliently deformable in all directions,

an inlet, and

an outlet fixed in position relative to said walls,

wherein the outlet is connected to an energy release collection system, and
wherein said cell is in contact with a turbulent fluid/liquid environment which repeatedly distorts said cell, capturing, distortion forces momentarily within its resiliently deformable strengthened elastic walls, releasing such forces through the outlet and relaxing said hydraulic power cell to its pre-distortion configuration.

In the hydraulic power cell the distortion forces expand and contract the hydraulic power cell by entering fluid/liquid into said cell through the inlet. Alternatively, opening the inlet admits restoring fluid/liquid volume to relax said hydraulic power cell to its pre-distortion configuration. The inlet and outlet are preferably equipped with a means to prevent back-flow of the fluid/liquid such as for example a check valve/one directional valve. The energy release collection transfers the captured hydraulic force to a hydraulic force utilizing end point, which preferably converts the hydraulic force into electrical energy.

In another embodiment the invention provides a floating device for capturing, dissipating and storing wave action energy from a body of water in motion comprising:

at least two moorings positioning the floating device in the body of water, and

at least one hydraulic power cell having elastic walls which are resiliently deformable,

wherein the at least one hydraulic power cell is connected to a hydraulic force utilizing end point, and
wherein the body of water in motion distorts the at least one hydraulic power cell capturing, storing, releasing, collecting and distributing water motion energy generated in said at least one hydraulic power cell to said hydraulic force utilizing end point.

The floating device preferably comprises a multitude of hydraulic power cells, connected to the hydraulic force utilizing end point, having elastic walls is in the form of a sphere, oval, chamber or tube and having an inlet and an outlet. Preferably, the inlet and the outlet are equipped with a means to prevent back-flow of fluid/liquid such as for example a check valve/one directional valve. Preferably the hydraulic force utilizing end point converts the hydraulic force to electrical energy.

In another embodiment the present invention provides the above floating device in the form of a floating mat comprising:

a flexible upper skin member located primary above the waterline, and

a stiff bottom skin member primary below the waterline,

wherein the at least one hydraulic power cell is positioned between the flexible upper skin member and the stiff bottom skin member such that the wave action energy distorts the flexible upper skin member and the at least one hydraulic power cell while the stiff bottom skin member resists distortion, and
wherein at least one hydraulic power cell is connected to a hydraulic force utilizing end point through the stiff bottom skin member.

In another embodiment the present invention provides the above floating device, wherein the at least one hydraulic power cell comprises:

a tubular member having strengthened elastic walls which are resiliently deformable in all directions,

an inlet, and

an outlet fixed in a position relative to said walls,

wherein the outlet is connected to the hydraulic force utilization end point,
wherein the at least one hydraulic power cell is positioned on top side of a stiff floating skin member having a bottom side which is primarily submerged below the waterline and a top side which primarily at or above the water line, and

wherein the at least one hydraulic power cell is in contact with a turbulent fluid/liquid environment which repeatedly distorts said cell, capturing distortion forces momentarily within its resiliently deformable strengthened elastic walls, releasing such forces through the outlet and relaxing said hydraulic power cell to its pre-distortion configuration.

The above floating device may comprise at least two hydraulic power cells positioned adjacent to each other on the stiff floating skin member, and at least one protruding stiff member positioned in between and attached to both the adjacent hydraulic power cells and flexibly attached to the stiff floating skin member by means of a connection such that the movement of the protruding stiff member is independent from the movement of the floating skin member, wherein the movement of the at least one protruding stiff member due to turbulence of the body of water repeatedly distorts and relaxes the at least two hydraulic power cells capturing distortion forces momentarily within its resiliently deformable strengthened elastic walls, and releasing such forces through the outlet.

Any of the above floating devices may be partially submerged below the waterline such that the outer edge of the floating device is below the waterline and a central part of the device is above the water line providing floatation, such that the submerged edge induces a wave to break onto the floating device, wherein ratio of the distance of the outer edge from the center of the floating device and the height of the wave is 5:1 to 20:1 and wherein the floating device slopes from the center to the outer edge of the floating device at an angle from the horizontal water line between 6°-24°.

In another embodiment the present invention provides a non-floating device for capturing and storing wave action energy from a body of water in motion comprising:

a stiff support member,

at least two moorings for anchoring the device on the shoreline,

at least one hydraulic power cell having elastic walls which are resiliently deformable, an inlet and an outlet,

an hydraulic force conversion end point, and

a connection means from the at least one hydraulic power cell to the hydraulic force conversion end point,

wherein the hydraulic force conversion end point converts the wave action energy from the body of water into electrical energy,
wherein the connection means traverses through or within the stiff support member, and
wherein the body of water in motion distorts the at least one hydraulic power cell capturing, storing, releasing, collecting and distributing water motion energy generated in said at least one hydraulic power cell to said hydraulic force conversion end point.

The non-floating device is preferably anchored to a point above the high-tide and below the low-tide points on the shoreline such that the non-floating device extends above the high-tide and below the low-tide points. Preferably the non-floating device comprises at least two hydraulic power cells, containing a tubular member having strengthened elastic walls which are resiliently deformable in all directions, an inlet, and an outlet fixed in a position relative to said walls, positioned adjacent to each other on the stiff support member, and at least one protruding stiff member positioned in between and attached to both the adjacent hydraulic power cells and flexibly attached to the stiff support member by means of a connection such that the movement of the protruding stiff member is independent from any movement of the support member, wherein the movement of the at least one protruding stiff member due to turbulence of the body of water repeatedly distorts and relaxes the at least two hydraulic power cells capturing distortion forces momentarily within its resiliently deformable strengthened elastic walls, and releasing such forces through the outlet. The inlet and outlet of the hydraulic power cell are preferably equipped with a means to prevent back-flow of fluid/liquid such as a check valve/one directional valve. Optionally, the non-floating device includes a wave action energy storage system.

Many other improvements, variations and applications will be apparent to those skilled in the art.

### BRIEF DESCRIPTION OF THE DRAWINGS

FIG. 1: illustrates a hydraulic power cells with elastic walls that are resiliently deformable in all directions, A) a hydraulic power cell, B) a hydraulic power cell with elastic wall strengthened with heavier same material, C) a hydraulic power cell with elastic wall strengthened with metal or cable-like reinforcement, D) a hydraulic power cell with elastic wall strengthened with internal metal rings, E) a hydraulic power cell with elastic wall strengthened with spring-like spiral wound internal rings, and F) hydraulic power cell having an elastic wall and check valve and check valve inserter assemblies.

FIG. 2: illustrates a hydraulic power cell with strengthened elastic walls in A) open to environment (sea) or B) in closed liquid loop arrangement.

FIG. 3: illustrates a hydraulic power cell with two tensioned cylinders.

FIG. 4: illustrates schematically a floating device in the form of a mat (A) composed spherical and ovaloid hydraulic power cells and a cross-section (B).

FIG. 5: illustrates schematically functioning of a floating device in the form of a mat composed of spherical and ovaloid hydraulic power cells (A) and a more detailed cross-section showing wave action (B).

FIG. 6: illustrates schematically functioning of a floating device in the form of a mat composed of vertical tubular hydraulic power cells.

FIG. 7: illustrates a floating device in the form of a mat composed of hydraulic power cells having strengthened elastic walls.

FIG. 8: illustrates a floating device in the form of a mat composed of protruding members positioned between two hydraulic power cells having strengthened elastic walls.

FIG. 9: illustrates schematically functioning of a floating device in the form of a mat composed of protruding members in between two hydraulic power cells having strengthened elastic walls in capturing wave turbulence. The FIGS. 9A-C represents a series of two hydraulic power cells and a protruding member starting in a relaxed state (A) and rocking back and forth (B) and (C) due to turbulence.

FIG. 10: illustrates schematically a wave energy storage system, A) a wave energy storage system comprising a series of non-strengthened hydraulic power cells with ends capped, B) a balloon-like non-strengthened hydraulic power cell with ends restricted.

FIG. 11: illustrates schematically a floating device in the form of a mat comprising hydraulic power cells, an energy release collection system, an wave energy storage system, and a hydraulic force utilizing end point.

FIG. 12: illustrates an open water moored floating device in the form of a mat with hydraulic power cells.

FIG. 13: illustrates a non-floating device in the form of a mat comprising hydraulic power cells having elastic walls.

FIG. 14: illustrates schematically functioning of A) a non-floating device comprising hydraulic power cells and protruding members in capturing wave action energy at the shoreline, and B) detail illustrating schematically the hydraulic power cell having strengthened elastic walls.

FIG. 15: illustrates A) a floating device in the form of a mat of which the edges are submerged and the center is above surface having wave breaking characteristics, B) with hydraulic power cells shown on top of the mat and energy release collection system attached to hydraulic power cells.

FIG. 16: illustrates a complex independently moored, wave breaking, wave motion capturing floating device having hydraulic power cells.

### DETAILED DESCRIPTION OF THE INVENTION

The invention relates to a hydraulic power cell which may be used in a floating or non-floating structure comprising a series of hydraulic power cells to capture the majority of motion energy of widely varying frequencies and magnitudes which exist in any body of water, preferably at sea. The size and magnitude of activity of the body of water naturally have a major bearing on the magnitude of energy available. The invention makes use of the ability to take the random and sporadic energy from the various elastic hydraulic power cells and storing it in a water energy storage system which stores and dampens energy surges so that they can be tapped on a relatively steady and regular basis.

While it is known that many attempts have been made to harness various energy from the sea, none of these efforts are believed to involve the capture of several types of energy from the sea, the extensive use of a selectively elastic mat in the invention, or the specific components of the invention.

The invention is directed to a variety of hydraulic power cells (HPC), generally composed of selectively elastic materials, which capture the surges and waves of water motion in a dynamic water environment and selectively discharge such energy through a variety or individual hydraulic power cell combinations through a series or individual hydraulic lines, which may be part of a closed system or an open system. Usually a water energy storage system (WESS) composed of selectively elastic hydraulic power storage cells is included to serve as storage and dampening device for the power surges from the hydraulic power cells in the flow line and on to a hydraulic flow power converter usually a high head, medium head, or low head water turbine, a reciprocating hydraulic piston system, a diaphragm reciprocating system, all of which convert flow into rotating motion which would normally drive a generator and its related electrical power output and control, or to another motion converting system or end use.

An important element of the current invention is its capability to cause waves, large and small, to break thereby capturing the maximum energy generation point of a wave, i.e. the break energy is far more than the rise and fall wave energy.

In addition to the obvious advantage of the Marine Energy Extraction invention, specifically the novel conversion of ocean wave energy into efficient clean useful power, the current invention provides some other advantages and novel aspects. As a flexible, environmental resistant structure composed of hydropower cells and floating mat/pad-like configuration, the structure is less susceptible to ice damage in winter-like conditions than conventional floating structures. Likewise, the flexible floating structures are designed to absorb trauma such as being struck by small craft, or in the case of collision by large craft, not endangering such craft. Likewise, the “sea kindly” configurations provide lower cost maintenance, location changes and docking ease. The structures can literally be “beached” for inspection, maintenance and the like.

The ability to generate power offshore: with a surviving, versatile flexible structure can also enable a variety of novel, useful functions. Some examples are Marine Energy Extraction (MEX) structures to serve as navigational aids (self-powered lights, transmitters and the like) including providing an emergency rescue platform or lifeguard structure for mariners and/or vessels; power sources positioned in the vicinity of sub-sea oil and gas pipelines to provide heating and other flow assurance functions regarding such flow lines; efficient breakwaters to protect ports and/or shorelines; and utilization of the artificial reef-like characteristics to augment offshore fish supplies, i.e. fish sanctuaries (the hydro power mat undersides). The unique hydro-cell mat configurations also provide cleanable surfaces (during clement weather) for routine maintenance. The hydraulic power flow created by the novel structure can also be used directly as a pressurized water stream. Extremes of such application would be decorative fountains to high pressure saltwater subsea hydrocarbon formation reinjection and/or pressurization.

Another important feature of the invention relates thereto that substantially all of the materials of construction have the characteristic of being resiliently deformable in all directions. A similar characteristic is described in U.S. Pat. No. 3,818,708 (regarding a floating barrier). In effect, balanced elasticity is important to both power generation and survivability.

While the present invention is disclosed with reference to the embodiments described herein, it should be clear that the current invention should not be limited to such embodiments. Therefore, the description of the embodiments herein is only illustrative and should not limit the scope of the invention as claimed.

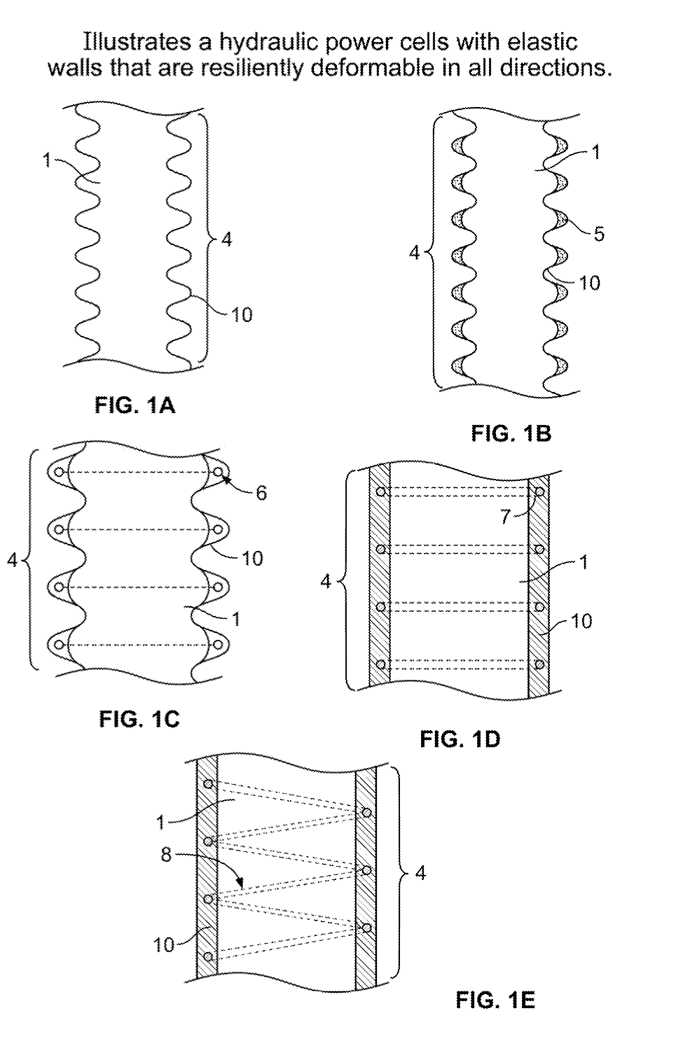

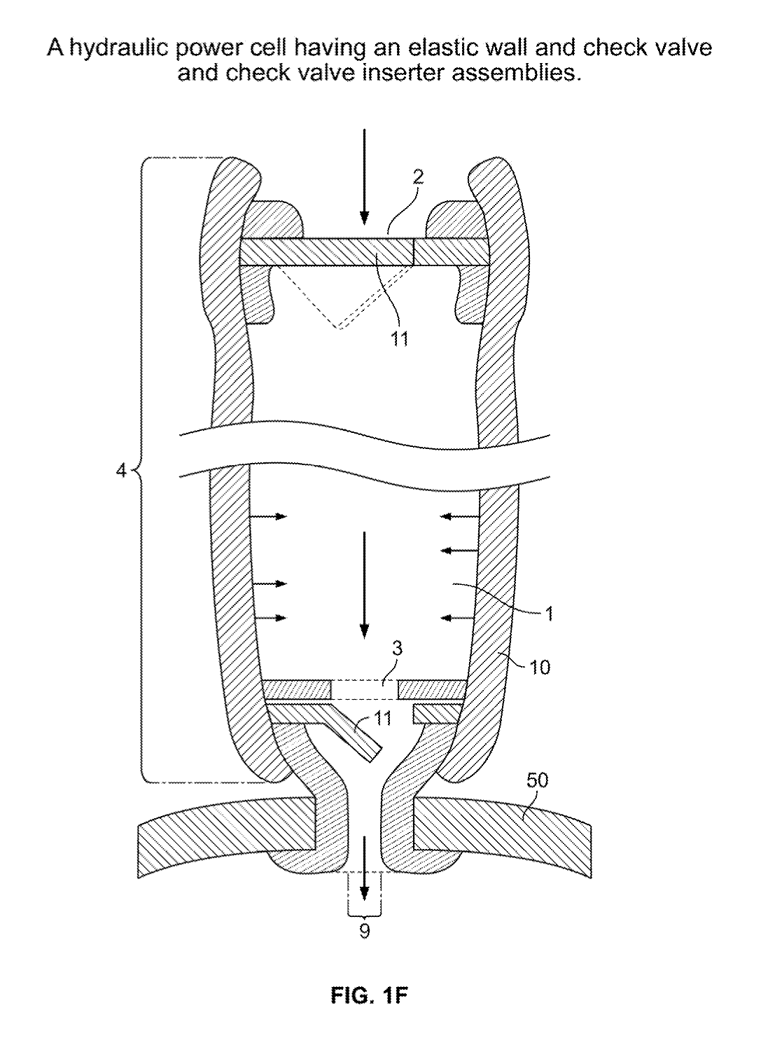

An exemplary embodiment of the hydraulic power cell of the current invention is illustrated in FIGS. 1A-1F. FIG. 1A illustrates a hydraulic power cell 1, which captures, stores and releases energy comprising: a tubular member 4, having strengthened elastic walls 10, which are resiliently deformable in all directions. As shown in FIG. 1B the elastic walls 10 of the tubular member 4 of the hydraulic power cell 1, may be strengthened at discreet intervals with more of the same material 5. As shown in FIG. 1C the elastic walls 10 of the tubular member 4 of the hydraulic power cell 1, may be strengthened at discreet intervals with cable-like or metal reinforcements 6. As shown in FIG. 1D the elastic walls 10 of the tubular member 4 of the hydraulic power cell 1, may be strengthened at discreet intervals with metal ring reinforcements 7 or metal spiral-like reinforcements 8 as shown in FIG. 1E. The hydraulic power cell 1 can also be described as a tube-type hydraulic power cell which is composed of a hose-type cylinder of highly elastic material which has its outer walls 10 selectively strengthened to resist significant diminution of the tube diameter when the tube is stretched. The usual structure is a ridged tube with the ridges 5 being of the same tube material, the ridges 5 themselves resisting inward deformation during stretch, or the same structure with the ridges strengthened with additional or similar elastic material, or an ordinary hose-like tube with internal strengthening such as with fixed internal wire rings 6, 7 or internal spiral rings 8.

These reinforcements of the elastic walls 10 of the hydraulic power cell 1 provide sufficient resilience in the tubular member 4 in order for it to return to its pre-distortion configuration after wave action has distorted the hydraulic power cell 1. The strengthened elastic walls 5 of the tubular member 4 and its resulting resiliency provide that the hydraulic power cell 1 can contract and expand without substantially changing the radius/diameter of the tubular member 4. As a result the change in volume of the tubular member 4 of the hydraulic power cell 1 is proportional to the difference in length between the distorted configuration due to wave action and the relaxed configuration towards which the hydraulic power cell would want to return in the absence of any wave action. Typically, depending on the elasticity of the elastic walls 10 of the tubular member 4, the elongated capability generally is in the 200%-400% range, the diameter decreases slightly while the length increases significantly thereby causing the internal volume of the tube to increase dramatically. Considering the difference in length of the tubular member 19 when elongated is about 2 to 4 times and thus the volume of the hydraulic power cell 1 may change by a factor of 2 to 4. In contrast in a non-strengthened hydraulic power cell not only the length of the tubular member but also the radius/diameter changes substantially resulting in a much smaller change in volume between the distorted configuration and the relaxed configuration.

As shown in FIG. 1F, the hydraulic power cell 1, comprises an inlet 2 on one end of the tubular member 4 and an outlet 3 on either the same or as shown here on the same end of the tubular member 4 fixed in a position relative to the elastic walls 10. The outlet is connected to an energy release collection system 9, and which may traverse a support member 50 onto which the hydraulic power cell 1 is attached. Both the inlet 2 and outlet 3 have selective valve 11 which allows the flow of fluid/liquid in only one direction (check valve/one direction valve). The selective “valve-type” arrangement enables a liquid, normally water, or a gas to enter the tubular member 4. When the stretching force is removed the potential energy stored in the tube in the form of elasticity attempts to restore the tube to its original configuration and in the normal application forces the liquid or gas out of the tubular member 4 through selective valving 11 and routing chambers, normally hoses.

Generally in capturing wave action the hydraulic power cell 1 is in contact with a turbulent fluid/liquid environment which repeatedly distorts the hydraulic power cell 1, capturing distortion forces momentarily within its resiliently deformable strengthened elastic walls 10, releasing such forces through the outlet 3 and relaxing the hydraulic power cell 1 to its pre-distortion configuration. In the hydraulic power cell 1 the distortion forces expand and contract the hydraulic power cell by entering fluid/liquid into the hydraulic power cell 1 through the inlet 2 and releasing such fluid through the outlet 3. Alternatively, opening the inlet 2 admits restoring fluid/liquid volume to relax the hydraulic power cell 1 to its pre-distortion configuration. The inlet 2 and outlet 3 are preferably equipped with a means to prevent back-flow of the fluid/liquid such as for example a check valve/one directional valve 11. The inlet 2 may be of a different size than the outlet 3, preferably the diameter of the inlet 2 is larger than the diameter of the outlet 3. Typically the difference in diameter ranges from 1.1 times to 5 times, preferably about 1.5 times.

The energy release collection system 9 transfers the captured hydraulic force to a hydraulic force utilizing end point, which preferably converts the hydraulic force into electrical energy.

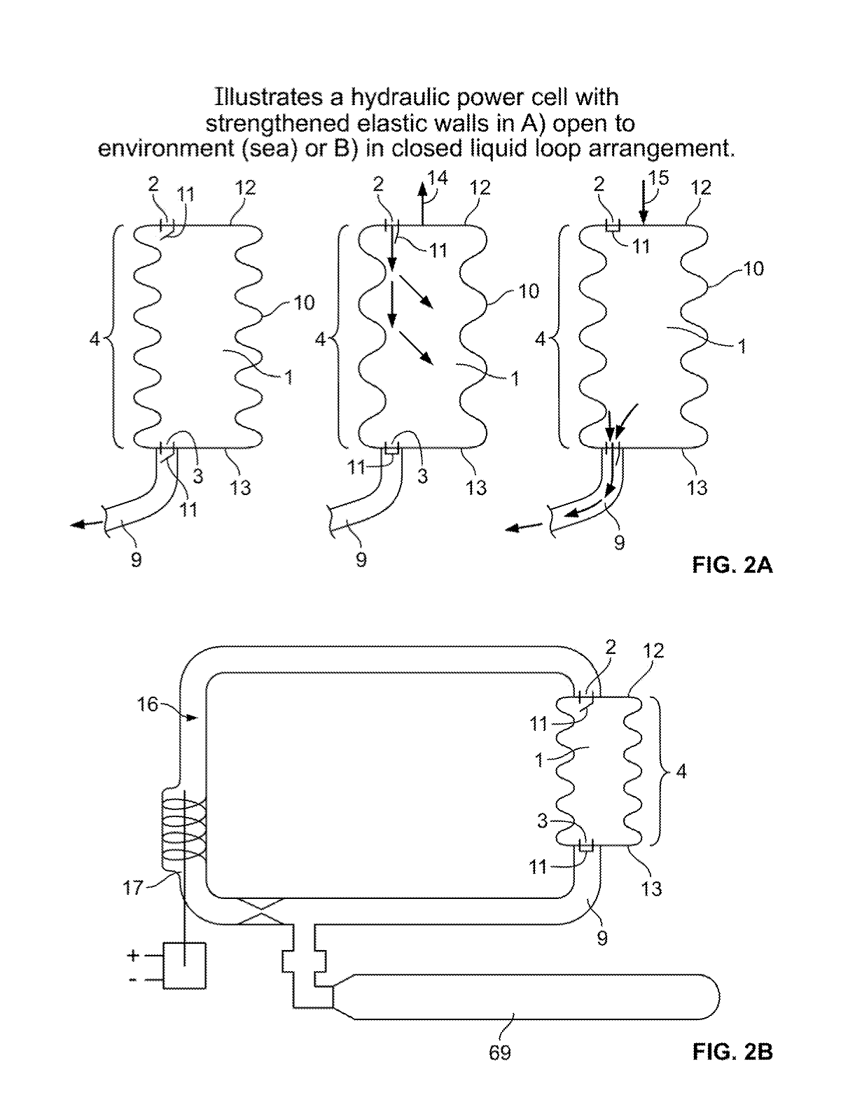

FIG. 2A illustrates a hydraulic power cell 1 of the current invention in a typical open system configuration, wherein inlet 2 and outlet 3 are at opposing ends 12 and 13 of the tubular member 4 and each contains a check valve/one direction valve 11 which directs the flow of fluid/liquid through the energy release collection system 9. Fluid/liquid enters the hydraulic power cell 1 through the inlet 2 as a result of wave action through a one-way valving arrangement 11 from the external liquid environment, thereby elongating the hydraulic cell 1 and the elastic strengthened walls 10 due to distortion force 14. Upon relaxing of the hydraulic power cell 1 due to the action of elastic relaxation force 15 the outlet 3 releases the fluid/liquid into the energy release collection system 9. In a closed system as shown in FIG. 2B the hydraulic power cell 1 is in a closed loop wherein inlet 2 and outlet 3 may be on the same or opposite ends 12 and 13 of the tubular member 4. The inlet 2 receives fluid/liquid from the recirculation loop 16 and the outlet 3, through the selective valving 11, releases fluid/liquid into the energy release collection system 9 which transfers the hydraulic force in an hydraulic force utilization end point, here a converter into electrical energy 17, which energy release collection system 9 may optionally include a wave energy storage system 69. In the hydraulic power cell 1 wherein the fluid/liquid is in a closed system the fluid/liquid is selected from sea water, filtered sea water, saline water, water, and a biological acceptable hydraulic fluid. Further, any closed loop hydraulic power cell 1 or hydraulic power cell 1 combination with a separate pressurization capability can maintain the internal cell or system pressure at a pre-set level or a variable level which increases the energy capture capability in order to achieve maximum cell or system efficiency.

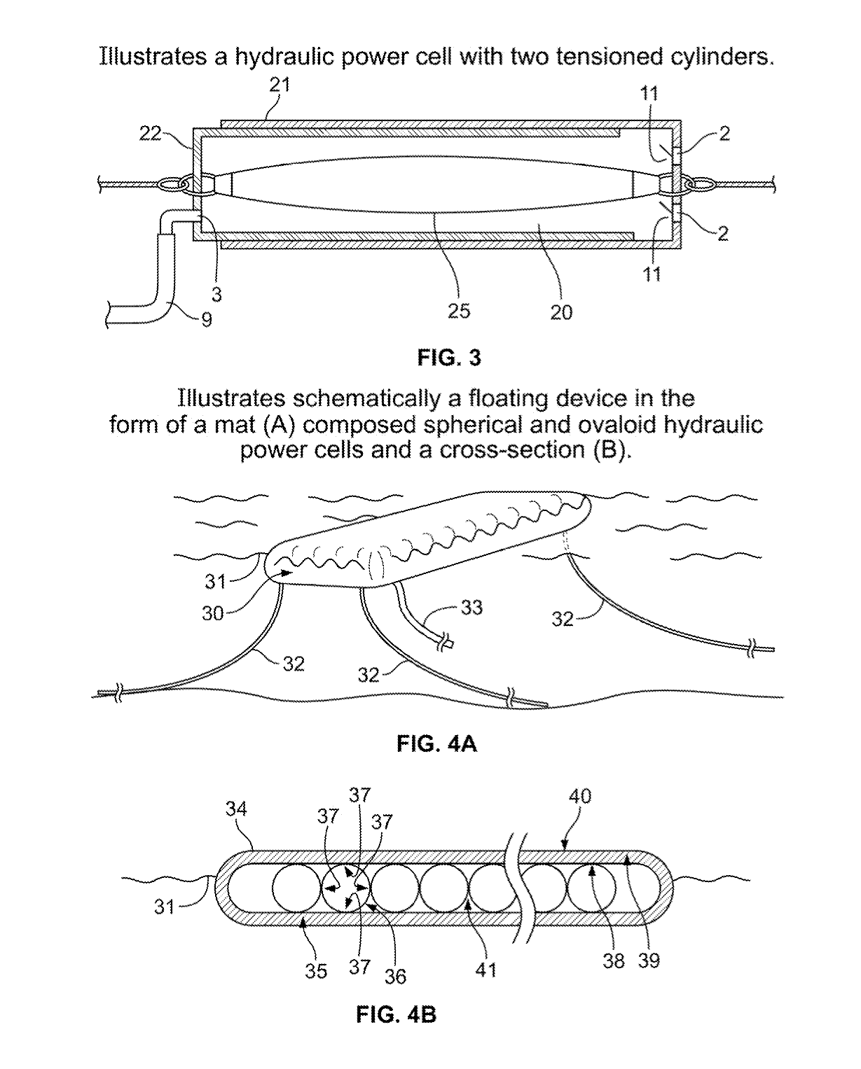

FIG. 3 illustrates a simple tensioned piston hydraulic power cell 20, a different type of power cell which may also be used in the floating and non-floating devices of the current invention, and in which two metal cylinders 21, and 22, each closed at one end and being of slightly different diameter are internally connected by a strong, highly elastic stretchable rubber-like strand 25 which stores potential energy as the cylinders move apart and restores the cylinders to a closed position when the separating force eases or ceases. A system of selective intake 2 and discharge 3 valves 11 which direct a liquid flow generally in one direction into a fluid power line or energy release collection system 9. Other power cells that may be included in the floating or non-floating devices of the current invention include spherical, ovaloid, or chambered power cells which are constructed of selectively elastic material and which will attempt to restore themselves to their basic configuration after being distorted by an external or internal force. A similar system of selective intake and discharge valving is to control and route flow.

FIGS. 4A and B (a cross-section) illustrate an embodiment of a floating device 30 for capturing, dissipating and storing wave action energy from a body of water in motion comprising: at least two moorings 32 positioning the floating device 30 in the body of water, and at least one hydraulic power cell 36 having elastic walls which are resiliently deformable. The floating device 30 is partially submerged below the water line 31. The at least one hydraulic power cell 36 is connected to a hydraulic force utilizing end point through a hydraulic flow line 33. The floating device 30 preferably comprises a multitude of hydraulic power cells 36, connected to the hydraulic force utilizing end point, having elastic walls is in the form of a sphere, oval, chamber or tubular member and having an inlet and an outlet. Preferably, the inlet and the outlet are equipped with a means to prevent back-flow of fluid/liquid such as for example a check valve/one directional valve. Preferably the hydraulic force utilizing end point converts the hydraulic force to electrical energy.

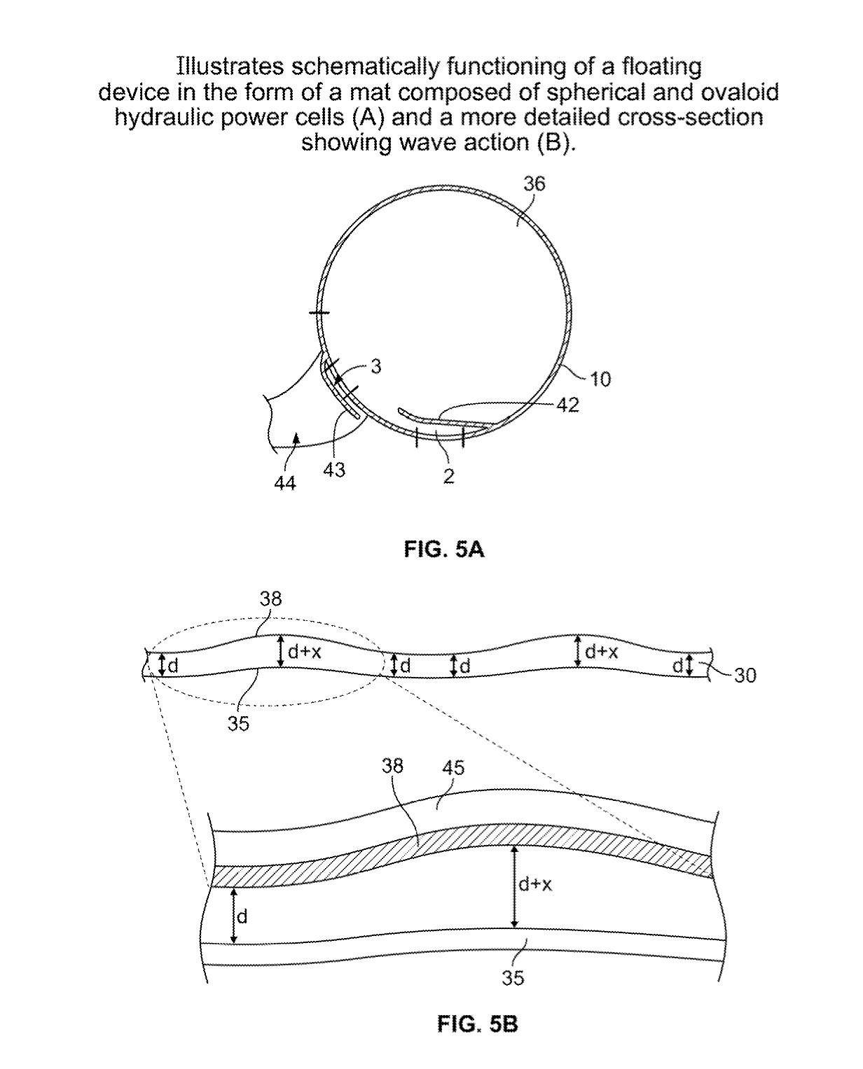

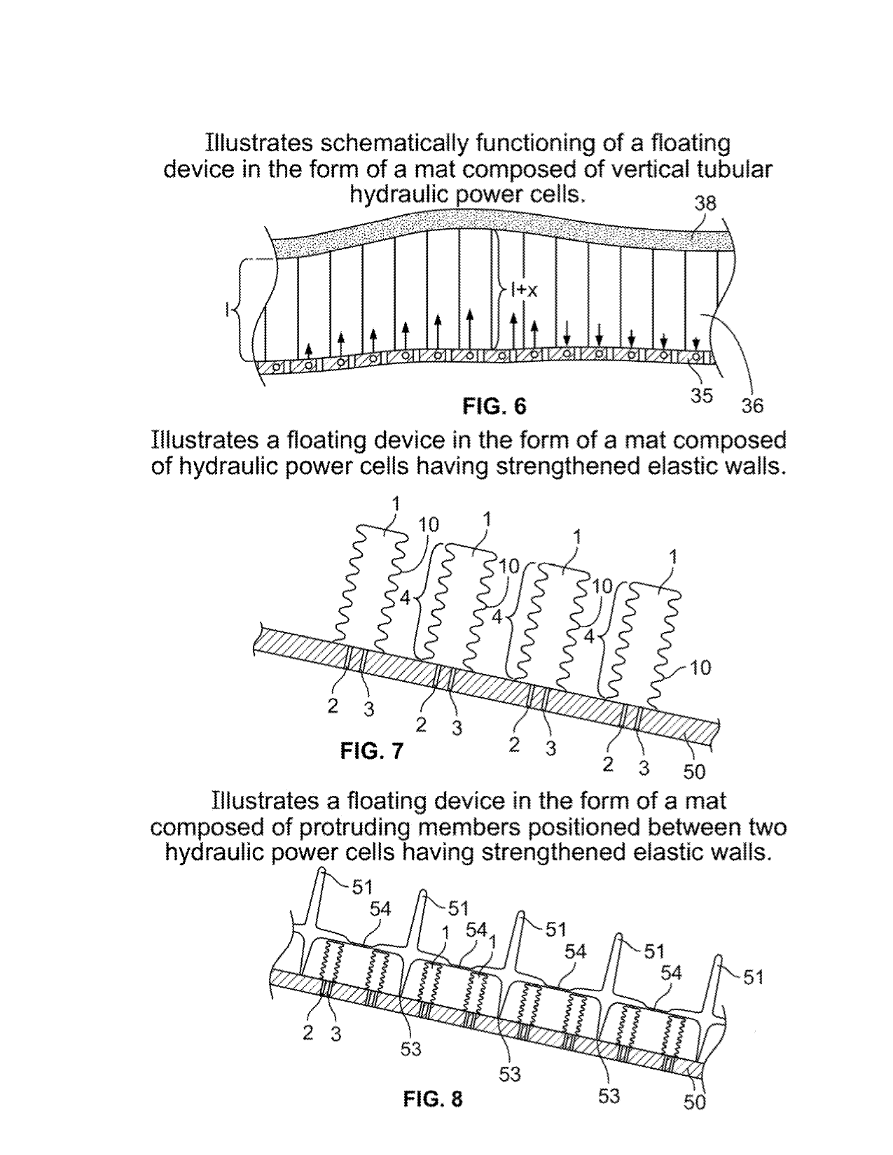

The floating device 30 provides a combination of spherical, ovaloid light tubular hydraulic cells 36, bonded via bond points 37, forming a layer within a mat-like structure in which an upper layer 38 (a flexible upper skin member located primary above the waterline 31) composed generally of a flexible flotation material 39 is encased in and bonded to a highly elastic skin 34, top and bottom of flotation material and which tries to follow wave formations passing across the upper surface 40, a second layer composed of spherical, ovaloid, or tubular cells 36 (any of which is a highly elastic relatively light weight and wall thickness) each of which is bonded or attached to the upper layer skin 38 and the bottom layer skin 35 (a stiff, relatively rigid bottom skin member primary below the waterline 31). The space in between the hydraulic power cells in the floating device comprises filler 41 which may be air, water or inert filler. FIGS. 5A and B show the hydraulic power cells 36 are distorted with corresponding volume changes as the upper layer 38 tries to correspond to a passing wave 45 form and the bottom layer 35, composed of a relatively rigid elastic material, resists thereby changing the diameter (d) of a hydraulic power cell/mat to for example an expanded diameter (d+x) before returning to pre-distortion diameter (d). The wave action may also first diminish the diameter (d−x) before returning to a pre-distortion diameter (d). A valving 42, and 43 and fluid routing system 44 (part of an energy release collection system) from and to each cell selectively controls flow. FIG. 6 illustrates a similar floating device in the form of a mat wherein the power cells 36 are tubular cells located within the floating device between the flexible upper skin member 38 and the relatively rigid, stiff bottom skin member 35 where the wave action distorts the length of the tubular cell (l) to for example a length (l+x) before returning to a pre-distortion length (l). Preferably the floating device in the form of a mat as described has dimensions such that the ratio of height:width is 1:20 to 1:30.

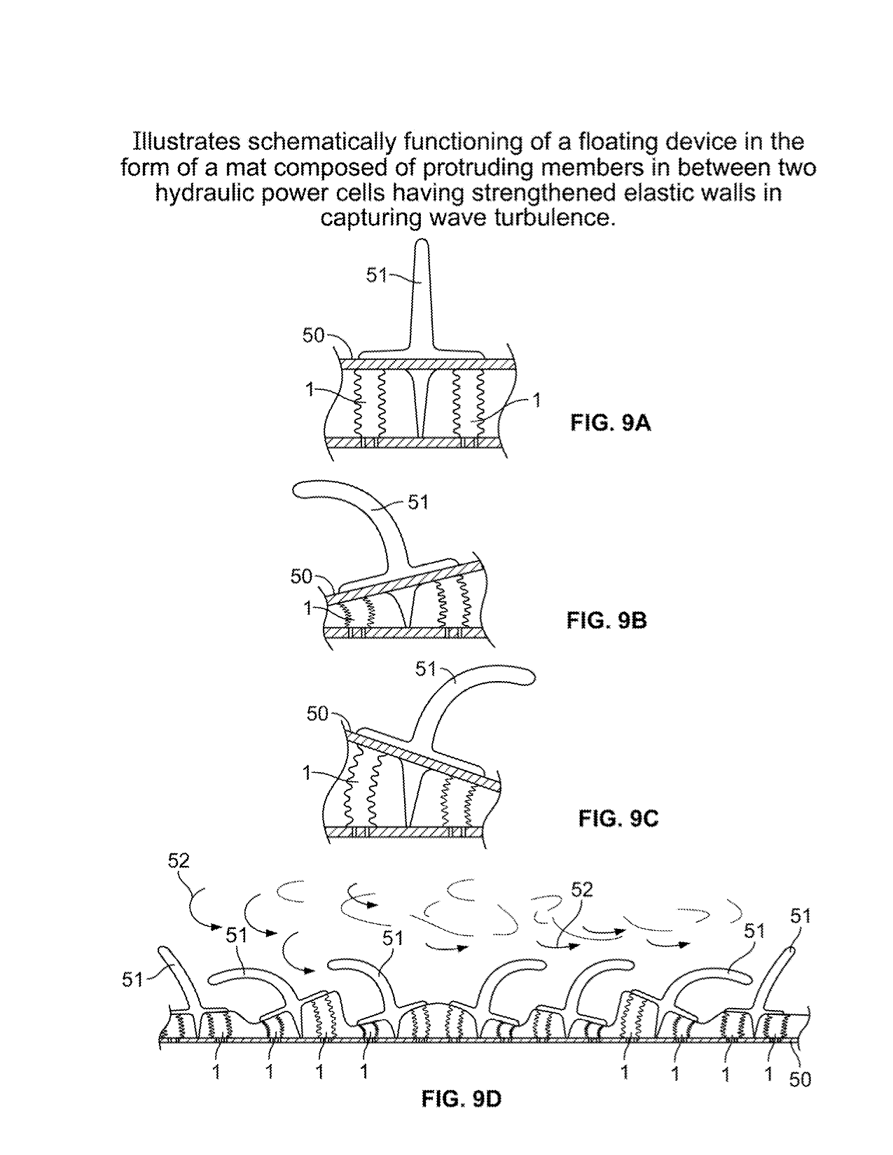

FIG. 7 illustrates an embodiment in which a combination of tubular hydraulic power cells 1 are incorporated into a mat 50 (a stiff floating skin member). The tubular hydraulic power cells 1 comprising a tubular member 4 have strengthened elastic walls 10 which are resiliently deformable in all directions, an inlet 2, and an outlet 3 fixed in a position relative to the elastic walls 10. The mat/stiff floating skin member 50 material may be a weight impregnated heavy sheet of rubber-like slightly elastic material. The turbulent water motion typically caused by breaking surf randomly and somewhat violently moves the projecting hydraulic power cells 1 thereby erratically, but constantly changing their volume and generating flow throughout the system of selective valving at inlet 2 and outlet 3 and routing of the hydraulic force in an energy release collection system towards an hydraulic force utilizing end point such as an electricity generating unit. In FIGS. 8 and 9 is illustrated a floating device as in FIG. 7 which further includes a vertical tin-like protruding member 51 to catch turbulence 52, typically from breaking waves and back-flow and usually with stiffening pads and a pivot point 53, flexibly attached to a mat/stiff floating skin member 50, to capture and enhance a multi-directional rocking motion to the hydraulic power cells 1. The protruding member 51, is attached to an adjacent protruding member 51 through a relatively highly elastic cross-section 54, such that the combination of protruding members 51 covers the hydraulic power cells 1 on the mat/stiff floating skin member 50. The FIGS. 9A-C represents a series of two hydraulic power cells and a protruding member starting in a relaxed state (A) and rocking back and forth (B) and (C) due to turbulence.

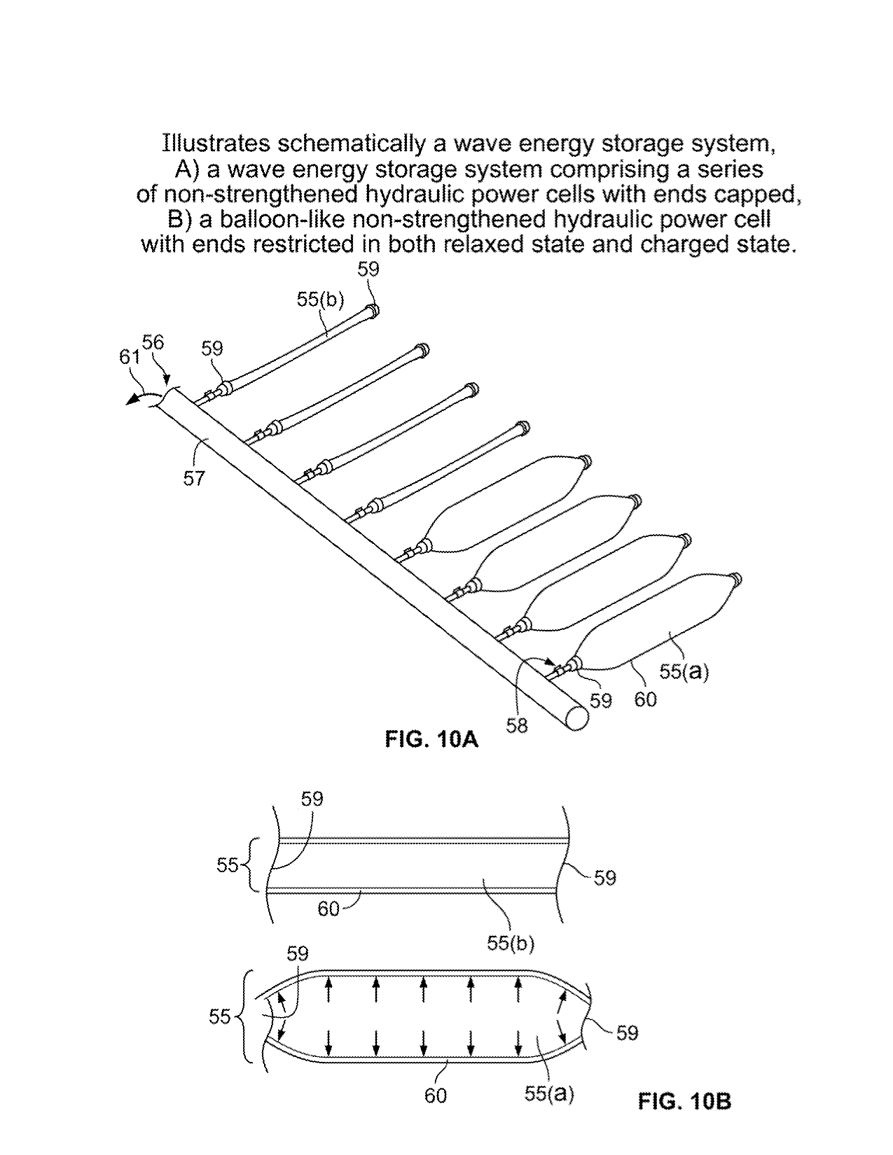

The hydraulic power cells in any of the above described floating devices release the captured and stored hydraulic force energy trough an energy release collection system. The energy release collection system may comprise of tubing to transfer the hydraulic force to an utilizing end point such as an conversion unit which transforms the hydraulic force into electric energy. The energy release collection system may further comprise a wave energy storage system (WESS) as is illustrated in FIGS. 10A and B. FIG. 10A illustrates combinations or multiples of hydraulic storage cells 55, either in charged/pressurized form 55(a) or without pressure 55(b), which are non-strengthened cells, utilized for storage of large surges of hydraulic energy from one or more of the source cells, on for example a floating device as previously or subsequently described, which stored energy can be used by the power conversion systems upon demand. Such combination or multiples of water energy storage cells 55 can also be used as surge dampeners, over pressure release systems, and hydraulic energy accumulators in general. In the wave energy storage system illustrated in FIG. 10A the in-flow 56 from the source enters a tube header 57 (preferably a metal tube header), which connects through the valve 58 and cap 59 to the storage cell 55 which has a non-strengthened elastic wall 60. When released the fluid/liquid will flow from the storage cell 55 through the cap 59 and valve 58 and through the header tube 57 creating an out-flow 61 towards the hydraulic force utilizing end point. In FIG. 10B a water energy storage cell 55, (no internal force present 55(b) and with internal force present 55(a) with ends restricted 59 (with cap)), which utilizes any of the preceding cells except that the energy force is exerted in a liquid form into the cell and such force can be selectively released through valving 58 and routing systems 57. The storage cell may be fixed in between caps 59 and at attached to a pressure and directional valve 58, which may be a pre-set flow restrictor for outflow, and a check valve for incoming flow.

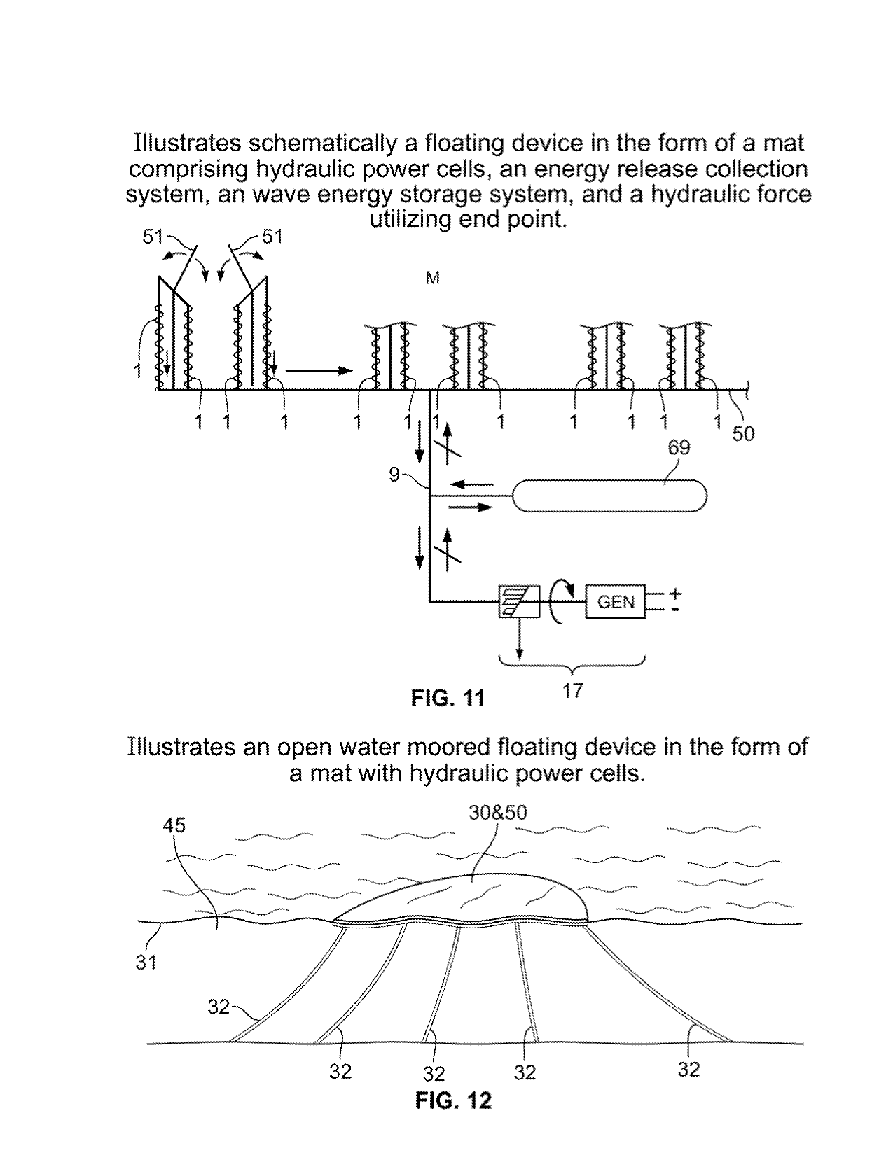

FIG. 11, illustrates a schematic embodiment of a floating device comprising a mat/stiff skin support member 50 with multiple hydraulic power cells 1 having strengthened elastic walls with an inlet and outlet, attached to the top of the mat and which may further include protruding member 51 attached to the hydraulic power cells 1, to capture, store and dissipate wave action energy. The outlets of the multiple hydraulic power cells 1 are attached to an energy release collection system 9, which transfers the hydraulic force to an utilizing end point 17, preferably to convert the hydraulic force to electrical energy. The energy release collection system may include a wave action storage system 69 as shown in FIG. 11. The floating device 30 or 50 in the form of a mat may be anchored at sea using moorings 32 at the water-line 31 in the path of oncoming waves 45 as shown in FIG. 12.

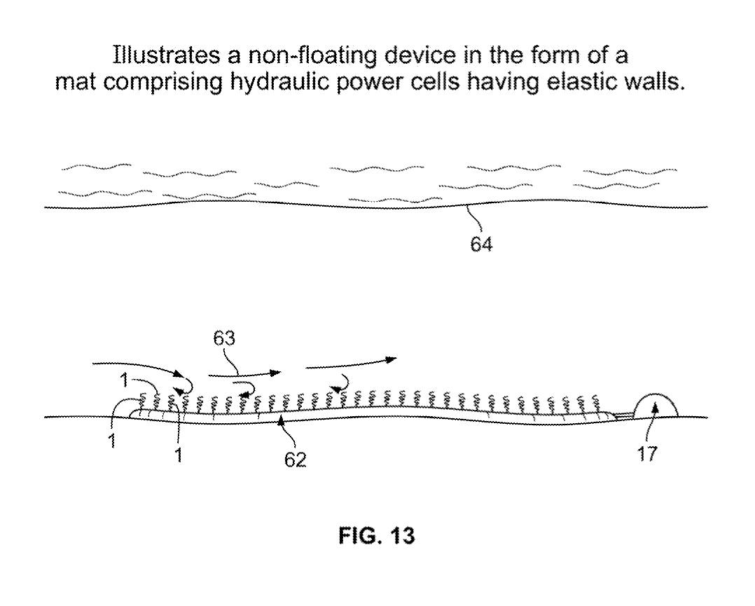

Another embodiment is illustrated in FIG. 13 showing a non-floating device which comprises a stiff support member 62 anchored on the ocean bottom and attached thereto hydraulic power cells 1 which have strengthened elastic walls which capture, store and release energy that distorts the hydraulic power cell 1 through current flow 63 and wave action from the surface 64. An outlet in the hydraulic power cell 1 transfers the hydraulic force to an energy flow converter 17, preferably converting hydraulic energy into electricity.

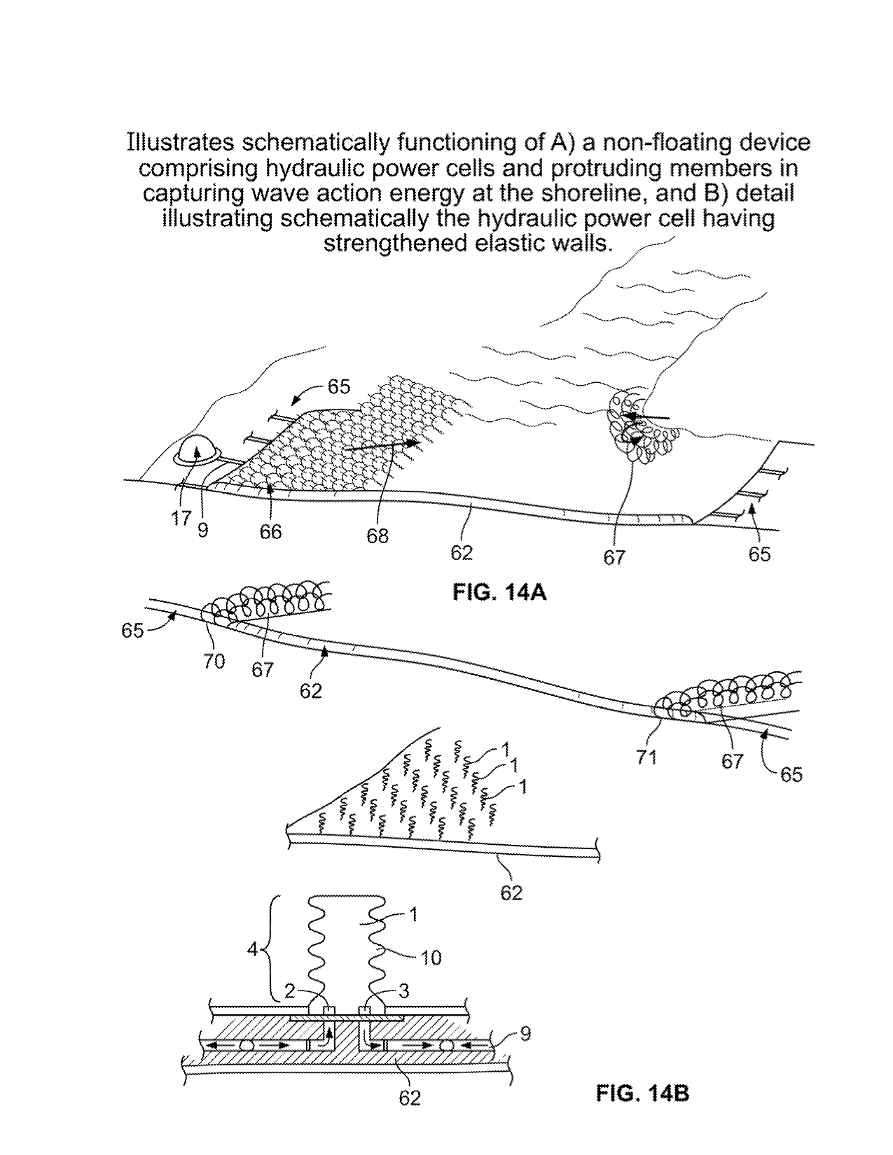

In FIG. 14 a non-floating device is illustrated which can be used in the shore-line. FIG. 14 A shows a heavy resilient support member/sheet 62 is anchored with shore-anchors 65 on shore and with moorings 65 at the ocean bottom. The support member 62 includes a multitude of hydraulic power cells underneath interlinked protruding members 66 (in the alternative the hydraulic power cells are not covered with interlinked protruding members 66) in order to capture the wave action of a breaking wave 67 at the shoreline and the continuously present back-flow 68. The captured and stored energy is dissipated through the energy release collection system 9 to transfer hydraulic force to a hydraulic force utilizing end point such as an electric energy converter 17. In FIG. 14B is illustrated that the non-floating device at the shore-line is anchored with moorings 65 at least above the high-tide mark 70 and below the low-tide mark 71 for more efficient operation. The non-floating device contains preferably a multitude of hydraulic powers cells 1 as is illustrated in FIG. 14B. These hydraulic power cells have an inlet 2 and outlet 3 at the same side of the tubular hydraulic power cell 1 with strengthened elastic walls 10 and which releases its captured and stored wave action energy through a energy release collection system 9.

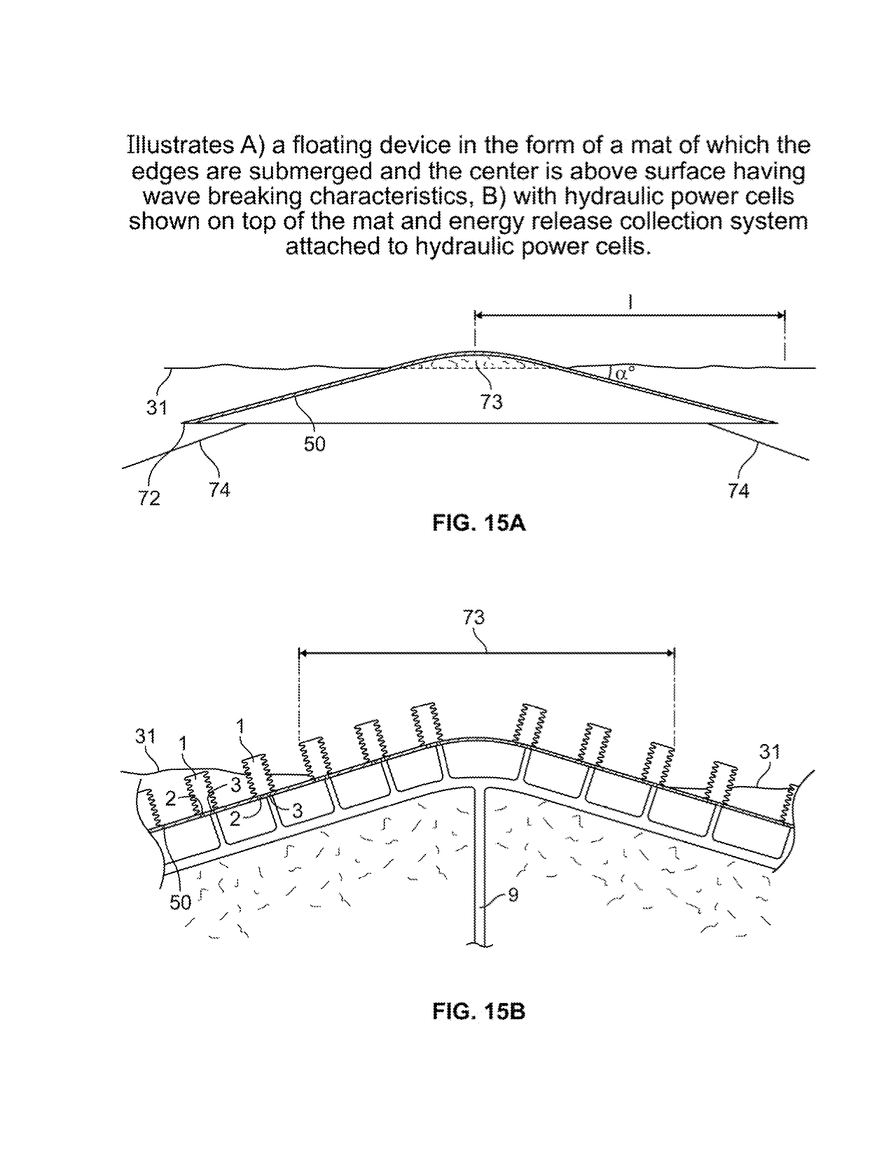

In another embodiment a floating device also incorporates wave breaking action as illustrated in FIGS. 15 A and B. A floating device mat 50 comprising hydraulic power cells 1 on its surface with an inlet 2 and an outlet 3 and an energy release collection system 9, is moored in the ocean through mooring lines 74. The floating device has an edge 72 that is submerged below the water-line 31. A central portion of the floating device 73 is above the surface. The mat 50 slopes from the center portion of the floating device 73 towards the edge of the floating device 72 at an angle and distance (I) from the central portion of the floating device 73 such that an incoming wave is induced to brake because of the progressively swallower depth towards the center of the floating device mat 50. The ratio of the distance of the outer edge 72 from the center of the floating device 50 and the height of an average wave is 5:1 to 20:1, preferably 6:1 to 18:1, more preferably 8:1 to 15:1, most preferably about 10:1 (which for an average 5 foot wave would mean that the outer edge 72 is at a distance of 50 foot from the center of the floating device 73. Preferably the angle from the horizontal water line 31 of the slope towards the edge 72 is between 6°-24°, preferably 8° C.-20°, more preferably 9°-15°, most preferably at about 12°.

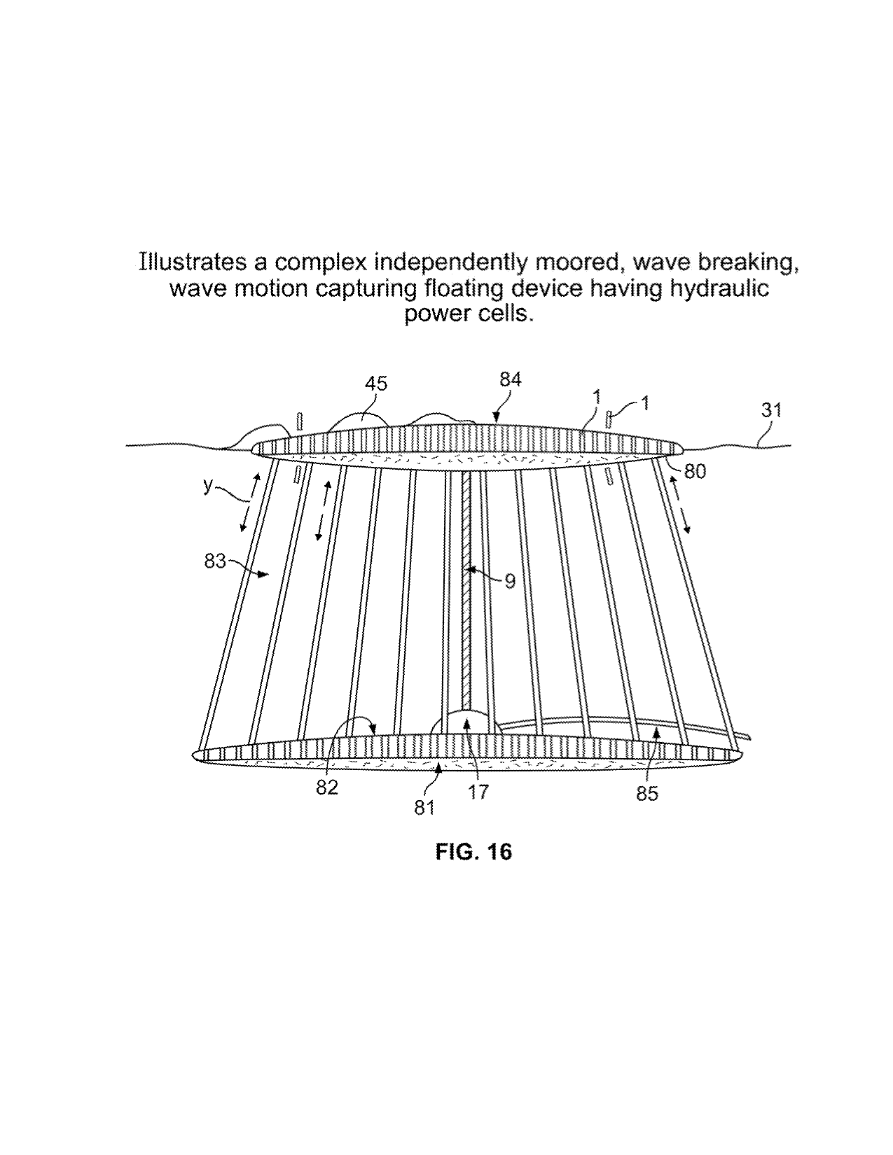

Another embodiment of a complex independently moored, wave breaking system with hydraulic power cell is illustrated in FIG. 16. A disc or mat 80 as described above with respect to FIG. 15 mat 50, floats on the surface/water-line 31 of the ocean wherein the dimensions are such that the disc or mat 80 has wave breaking characteristics similar to the mat 50 in FIG. 15. The disc or mat 80 includes a multitude of hydraulic power cells 1 onto the surface of the disc or mat 80. The complex floating structure may be moored onto the bottom of the ocean through a bottom mat/mooring disc 81, which may capture small current 82 on the bottom and tensioned hydraulic cells 83, which may be piston hydraulic power cells 20 between the upper floating mat 80 and the bottom mat/mooring disc 82. Wave action 45 distorts the top portion 84 of the mat 80 such that hydraulic power cells capture, store and release the hydraulic force. This hydraulic force collected through the hydraulic power cells is released into an energy release collection system 9. An hydraulic force utilization end point in the form of electrical energy conversion unit 17 converts the hydraulic force to a useful commodity through electric power cable 85.

The materials for construction of the hydraulic power cell of the current invention may be composed of a highly resilient, flexible plastic which confers balanced elasticity to the hydraulic power cell. The materials of the support members such as the upper skin member, the bottom skin member or the bottom support member need to provide sufficient buoyancy and stability to a floating device of the current invention.

These support members need to be resilient enough to withstand and absorb the shock of forces acting to distort the marine energy extraction device and resilient enough to return it to the original shape and resultant stability. Forces acting upon the device include waves crashing against the floating device, the continuous motion of the floating device as it rides over waves and swells, currents acting upon the device, ship overboard discharges striking the device, wind, ships or boats striking the floating device, debris striking the device, ice entrapping the floating device, ice floes or cakes colliding with the floating device, the floating device rubbing against or striking pilings, piers, bulkheads, or overhead obstructions, and other similar forces and conditions encountered in the water environment. The components and materials, which will be discussed in more detail subsequently, all have calculated degrees of tensile strength, durability, memory and resiliency which reasonably assure return to the pre-distortion shape regardless of expected forces acting upon the device. Specifically, the support members and the elastic walls of the hydraulic power cells are preferably composed of a highly resilient rubber or polyurethane-like formulation. The floating devices of the current invention may in addition contain flotation material composed of a highly resilient and flexible polyurethane or similar type foam. Each of the components of the invention has an inherent toughness, resiliency, and memory of varying degrees. The strengthened tubular walls of the hydraulic power cell of the current invention may include metal ring-like structures for added support.

The basic materials, components, and configurations of the invention provide the qualities necessary to guarantee the endurance of the marine energy extraction device in the sea environment for an extended period of time, generally in excess of two years.

The support members and the protruding member are preferably composed of ethylene propylene, polyurethane, or similar material based formulations having the following characteristics: high tensile strength, high tear strength, between 60 and 90 Shore A scale durometer hardness, ozone resistance, cold resistance to at least −20° F., hydrocarbon resistant, general chemical resistance, abrasion resistance, and further includes internal and external anti-fouling materials. The elastic walls of the hydraulic power cell are preferably composed of materials of similar characteristics such as for example a composition comprising Hycar (˜45%), PVC (˜45%) and plasticizers (˜10%), having between 60-90±5 Shore A scale Rockwell Durometer hardness, a tensile (ASTM D-412-68) strength of approximately 2,500 p.s.i., an approximate ultimate elongation of 380%, a longitudinal modulus (ASTM D412) of 650 p.s.i., a transverse modulus of 600 p.s.i., and being suitable for long term immersion—salt or fresh wat, suitable for anti-fouling (anti-marine growth) coating/painting or internal additives including anti-fungicides, and thermoplastic for plastic welding

The additional flotation material may be composed of closed cell polyethylene or polyurethane foam formulation of approximately 2.0 pounds per cubic feet (a flexible foam) or other closed cell materials of various compositions and densities that will maintain the floatation of the floating marine energy extraction device of the current invention and which is non-biodegradable.

Numerous modifications and alternative embodiments of the present invention will be apparent to those skilled in the art in view of the foregoing description. Accordingly, this description is to be construed as illustrative only and is for the purpose of teaching those skilled in the art to carry out the current invention. Details of the structure may vary substantially without departing from the spirit of the current invention, and exclusive use of all modifications that come within the scope of the disclosed invention is reserved.

### EXAMPLES

### Example 1 Calculation of Possible Energy Generation from Marine Energy Extraction

A simple calculation assumes an average changing head of one foot per second with the entire hydraulic mass (water moved through all hydraulic cell structures in a mat) weighing 10,000 tons. Extrapolating such an assumption yields 20,000,000 ft. lbs./sec. or 34,000 HP or 27,000 kw/sec.

### Example 2 Typical Specifications for Elastic and Flotation Material Used in Marine Energy Extraction (MEX) Components

| | | |
|---|---|---|
| 1) | Basic sheet or tubular stock | sheet thickness ⅛″-4.0″ |
| | | tube diameter 0.005″-12″ |
| 2) | Durometer | 60A ± 5 Rockwell |
| 3) | Basic ingredients: | Hycar ~45% |
| | | PVC ~45% |
| | | Plasticizers ~10% |
| 4) | Preferably no fabric or filler | |
| 5) | Tensile (ASTM D-412-68) | ~2,500 p.s.i. |
| 6) | Ultimate elongation | ~380% |
| 7) | Ross flexing test per ASTM D 1052-55 | |
| | 1″ × 6″ × ¼″ thick sample cycled 100 times/min. | |
| | through 90° - no failure at 1,000,000 cycles | |
| 8) | Tear strength - Graves Tear ASTM D 1004 | Longitudinal 190#/11 |
| | | Transverse 190#/11 |
| 9) | Puncture resistance MIL-P-6396C | Three tests: 135, 129, & 122# |
| 10) | Abrasion resistance ASTM D 1630-61 | 263, 244, 240 (3 results, values are relative |
| | | ratios to natural rubber. |
| 11) | Accelerated weathering - carbon arc without water | |

ASTM 0750-68 & G23-69
Tensile Tests (ASTM D-4 12-68)

| Time | Ultimate | Ultimate |
|---|---|---|
| (hrs.) | Tension | Elongation |
| 0 | 2,241 p.s.i. | 384% |
| 22 | 2,224 p.s.i. | 368% |
| 44 | 2,045 p.s.i. | 345% |
| 66 | 2,004 p.s.i. | 318% |
| 88 | 1,845 p.s.i. | 269% |

| | | |
|---|---|---|
| 12) | Low temp. embrittlement ASTM D 746 | Embrittlement impact @ −35° C., No failures |
| 13) | 100% modules ASTM D412 | Logitudinal 650 p.s.i. |
| | | Transverse 600 p.s.i. |
| 14) | Average elongation at failure ASTM D882 300% | |
| 15) | General characteristics | |
| | a) Suitable for long term immersion - salt or fresh water | |
| | b) Ozone resistant | |
| | c) Good oil resistance | |
| | d) Color - black or other solid color | |
| | e) Suitable for anti-fouling (anti-marine growth) coating/ | |
| | painting or internal additives including anti-fungicides | |
| | f) Thermoplastic for plastic welding | |
| 16) | Typical Specifications for Flotation-type Materials | |
| | a) Closed cell polyethylene foam approximate 2.0 pounds | |
| | per cubic foot - a “flexible” foam. | |
| | b) Other closed cell materials of various composition and densities. | |

### Example 3 Tube Formation for Use as Tubular Member for Hydraulic Power Cell

A basic hydraulic power cell is preferably composed of an inexpensively extruded tube of the typical elastic material, Example 2, within which, after cutting or otherwise producing a correct tube length, standard valving, check valve-like structures, usually of the same elastic material and optionally, connector provisions, are inserted, bonded or otherwise positioned such that a simple, elastically deformable, one-way liquid flow hydraulic power cell is configured. The HPC structure can be then utilized in an appropriate mat or other marine energy extraction system.

1. A hydraulic power cell which captures, stores and releases energy comprising:
a tubular member having strengthened elastic walls which are resiliently deformable in all directions,
an inlet, and
an outlet fixed in position relative to said walls,
wherein the outlet is connected to an energy release collection system, and
wherein said cell is in contact with a turbulent fluid/liquid environment which repeatedly distorts said cell, capturing distortion forces momentarily within its resiliently deformable strengthened elastic walls, releasing such forces through the outlet and relaxing said hydraulic power cell to its pre-distortion configuration.

2. The hydraulic power cell according to claim 1, wherein the distortion forces expand and contract the hydraulic power cell by entering fluid/liquid into said cell through the inlet.

3. The hydraulic power cell according to claim 1, wherein opening said inlet admits restoring fluid/liquid volume to relax said hydraulic power cell to its pre-distortion configuration.

4. The hydraulic power cell according to claim 1, wherein the elastic walls are strengthened with a wire means.

5. The hydraulic power cell according to claim 1, wherein the elastic walls are strengthened with the same elastic wall material at regular longitudinal intervals of the tubular member.

6. The hydraulic power cell according to claim 1, wherein the inlet and outlet are at opposing ends of the tubular member.

7. The hydraulic power cell according to claim 6, wherein the diameter of the inlet is larger than the diameter of the outlet.

8. The hydraulic power cell according to claim 1, wherein the inlet and outlet are equipped with a means to prevent back-flow of the fluid/liquid.

9. The hydraulic power cell according to claim 1, wherein the inlet and outlet are at the same end of the tubular member, wherein the hydraulic power cell is connected to a closed circulating system in which liquid/fluid traverses from the outlet through the energy release collection system and back to the inlet via a liquid/fluid reservoir.

10. The hydraulic power cell according to claim 9, wherein the fluid/liquid in the closed system is selected from sea water, filtered sea water, saline water, water, and a biological acceptable hydraulic fluid.

11. The hydraulic power cell according to claim 1, wherein the tubular member is treated with an anti-fouling composition.

12. The hydraulic power cell according to claim 1, wherein the energy release collection system comprises at least one elastic tubular member connected to a hydraulic force utilizing end point.

13. The hydraulic power cell according to claim 12, wherein the hydraulic force utilizing end point is a hydraulic force conversion end point converting the distortion forces of the turbulent fluid/liquid environment into electrical energy.

14. A floating device for capturing, dissipating and storing wave action energy from a body of water in motion comprising:
at least two moorings positioning the floating device in the body of water, and
at least one hydraulic power cell having elastic walls which are resiliently deformable,
wherein the at least one hydraulic power cell is connected to a hydraulic force utilizing end point, and
wherein the body of water in motion distorts the at least one hydraulic power cell capturing, storing, releasing, collecting and distributing water motion energy generated in said at least one hydraulic power cell to said hydraulic force utilizing end point.

15. The floating device according to claim 14, wherein the at least one hydraulic power cell having elastic walls is in the form of a sphere, oval, chamber or tube having an inlet and an outlet, wherein the outlet is connected to the hydraulic force utilizing end point.

16. The floating device according to claim 15, wherein the inlet and the outlet are equipped with a means to prevent back-flow of fluid/liquid.

17. The floating device according to claim 15 in the form of a floating mat comprising:
a flexible upper skin member located primary above the waterline, and
a stiff bottom skin member primary below the waterline,
wherein the at least one hydraulic power cell is positioned between the flexible upper skin member and the stiff bottom skin member such that the wave action energy distorts the flexible upper skin member and the at least one hydraulic power cell while the stiff bottom skin member resists distortion, and
wherein at least one hydraulic power cell is connected to the hydraulic force utilizing end point through the stiff bottom skin member.

18. The floating device according to claim 17, wherein the inlet and outlet of the at least one hydraulic power cell are in a closed circulating system in which liquid/fluid traverses from the outlet through the energy release collection system and back to the inlet via a liquid/fluid reservoir.

19. The floating device according to claim 18, wherein the fluid/liquid in the closed system is selected from sea water, filtered sea water, saline water, water, and a biological acceptable hydraulic fluid.

20. The floating device according to claim 17, wherein the floating mat is treated with an anti-fouling composition.

21. The floating device according to claim 14, wherein the at least one hydraulic power cell comprises:
a tubular member having strengthened elastic walls which are resiliently deformable in all directions,
an inlet, and
an outlet fixed in a position relative to said walls,
wherein the outlet is connected to the hydraulic force utilization end point,
wherein the at least one hydraulic power cell is positioned on top side of a stiff floating skin member having a bottom side which is primarily submerged below the waterline and a top side which primarily at or above the water line, and
wherein the at least one hydraulic power cell is in contact with a turbulent fluid/liquid environment which repeatedly distorts said cell, capturing distortion forces momentarily within its resiliently deformable strengthened elastic walls, releasing such forces through the outlet and relaxing said hydraulic power cell to its pre-distortion configuration.

22. The floating device according to claim 21, wherein the inlet and the outlet are equipped with a means to prevent back-flow of fluid/liquid.

23. The floating device according to claim 22, wherein the inlet and outlet of the at least one hydraulic power cell are in a closed circulating system in which liquid/fluid traverses from the outlet through the energy release collection system and back to the inlet via a liquid/fluid reservoir.

24. The floating device according to claim 23, wherein the fluid/liquid in the closed system is selected from sea water, filtered sea water, saline water, water, and a biological acceptable hydraulic fluid.

25. The floating device according to claim 21, wherein the floating device is treated with an anti-fouling composition.

26. The floating device according to claim 21, comprising
at least two hydraulic power cells positioned adjacent to each other on the stiff floating skin member, and
at least one protruding stiff member positioned in between and attached to both the adjacent hydraulic power cells and flexibly attached to the stiff floating skin member by means of a connection such that the movement of the protruding stiff member is independent from the movement of the floating skin member,
wherein the movement of the at least one protruding stiff member due to turbulence of the body of water repeatedly distorts and relaxes the at least two hydraulic power cells capturing distortion forces momentarily within its resiliently deformable strengthened elastic walls, and releasing such forces through the outlet.

27. The floating device according to claim 14, wherein the device is partially submerged below the waterline such that the outer edge of the floating device is below the waterline and a central part of the device is above the water line providing floatation, such that the submerged edge induces a wave to break onto the floating device,
wherein ratio of the distance of the outer edge from the center of the floating device and the height of the wave is 5:1 to 20:1 and wherein the floating device slopes from the center to the outer edge of the floating device at an angle from the horizontal water line between 6°-24°.

28. The floating device according to claim 27, wherein the ratio of the distance of the outer edge from the center of the floating device and the height of the wave is 10:1 and the floating device slopes from the center to the outer edge of the floating device at an angle from the horizontal water line between 12°.

29. The floating device of claim 14, wherein the connection from the at least one hydraulic power cell to the hydraulic force utilizing end point has a wave action energy storage system comprising at least one non-strengthened elastic tubular cell having an inlet and outlet,
wherein the inlet and outlet are equipped with a means to prevent back-flow of fluid/liquid,
wherein the inlet receives an influx of hydraulic force energy from the at least one hydraulic power cell through a connector, and
wherein the outlet has a valve controlling the release of the hydraulic force to a connection with the hydraulic force utilizing end, point, such that the wave action energy storage system stores hydraulic force energy from received from the hydraulic power cell and controls the release of the hydraulic force energy towards the hydraulic force utilizing end point.

30. The floating device according to claim 14, wherein hydraulic force utilizing end point is a hydraulic force conversion end point converting the wave action energy from the body of water in motion into electrical energy.

31. A non-floating device for capturing and storing wave action energy from a body of water in motion comprising:
a stiff support member,
at least two moorings for anchoring the device on the shoreline,
at least one hydraulic power cell having elastic walls which are resiliently deformable, an inlet and an outlet,
an hydraulic force conversion end point, and
a connection means from the at least one hydraulic power cell to the hydraulic force conversion end point,
wherein the hydraulic force conversion end point converts the wave action energy from the body of water into electrical energy,
wherein the connection means traverses through or within the stiff support member, and
wherein the body of water in motion distorts the at least one hydraulic power cell capturing, storing, releasing, collecting and distributing water motion energy generated in said at least one hydraulic power cell to said hydraulic force conversion end point.

32. The non-floating device according to claim 31, wherein the at least two moorings anchor the device to a point above the high-tide and below the low-tide points on the shoreline such that the non-floating device extends above the high-tide and below the low-tide points.

33. The device according to claim 31, wherein the at least one hydraulic power cell comprises:
a tubular member having strengthened elastic walls which are resiliently deformable in all directions,
an inlet, and
an outlet fixed in a position relative to said walls,
wherein the outlet is connected to the hydraulic force conversion end point, and
wherein the at least one hydraulic power cell is positioned on top side of a stiff support member.

34. The device according to claim 33, further comprising
at least two hydraulic power cells, containing a tubular member having strengthened elastic walls which are resiliently deformable in all directions, an inlet, and an outlet spatially fixed in position to said walls, positioned adjacent to each other on the stiff support member, and
at least one protruding stiff member positioned in between and attached to both the adjacent hydraulic power cells and flexibly attached to the stiff support member by means of a connection such that the movement of the protruding stiff member is independent from any movement of the support member,
wherein the movement of the at least one protruding stiff member due to turbulence of the body of water repeatedly distorts and relaxes the at least two hydraulic power cells capturing distortion forces momentarily within its resiliently deformable strengthened elastic walls, and releasing such forces through the outlet.

35. The device according to claim 31, wherein the inlet and the outlet are equipped with a means to prevent back-flow of fluid/liquid.

36. The device according to claim 35, wherein the inlet and outlet of the at least one hydraulic power cell are in a closed circulating system in which liquid/fluid traverses from the outlet through an energy release collection system and back to the inlet via a liquid/fluid reservoir.

37. The device according to claim 36, wherein the fluid/liquid in the closed system is selected from sea water, filtered sea water, saline water, water, and a biologically acceptable hydraulic fluid.

38. The device according to claim 31, wherein the device is treated with an anti-fouling composition.
